(19) United States
(12) Patent Application Publication
(10) Pub. No.: US 2018/0288791 A1
(43) Pub. Date: Oct. 4, 2018

(54) USER EQUIPMENT ASSISTED COORDINATION FOR SCHEDULED WIRELESS TRANSMISSIONS

(71) Applicant: NOKIA SOLUTIONS AND NETWORKS OY, Espoo (FI)

(72) Inventors: Samuli Heikki Turtinen, Ii (FI); Vinh Van Phan, Oulu (FI); Ling Yu, Kauniainen (FI); Kari Veikko Horneman, Oulu (FI)

(21) Appl. No.: 15/764,876

(22) PCT Filed: Oct. 26, 2015
(86) PCT No.: PCT/EP2015/074720

§ 371 Date: Mar. 30, 2018

(51) Int. Cl. H04W 72/12

(52) U.S. Cl. CPC H04W 72/1278; H04W 72/1226

(57) ABSTRACT

There is provided a method comprising receiving, at a user device associated with at least one cell, scheduling information from the at least one cell, the scheduling information comprising an indication of candidate resources for transmission of data in a transmission time interval, determining, in dependence on the candidate resources and at least a first threshold value, resources to be used for transmission of data in the transmission time interval and providing control information for transmission of data in the transmission time interval to the at least one cell, said control information comprising an indication of the determined resources.

### FIELD

The present application relates to a method, apparatus, system and computer program and in particular but not exclusively to user equipment assisted coordination for scheduled wireless transmissions in an ultra-dense small-cell multi-connectivity environment.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13) are targeted towards LTE-Advanced (LTE-A). LTE-A is directed towards extending and optimising the 3GPP LTE radio access technologies. Another proposed communication system is a 5G network

### SUMMARY

In a first aspect there is provided a method comprising receiving, at a user device associated with at least one cell, scheduling information from the at least one cell, the scheduling information comprising an indication of candidate resources for transmission of data in a transmission time interval, determining, in dependence on the candidate resources and at least a first threshold value, resources to be used for transmission of data in the transmission time interval and providing control information for transmission of data in the transmission time interval to the at least one cell, said control information comprising an indication of the determined resources.

The method may comprise transmitting data in the transmission time interval using the determined resources.

Determining resources to be used for transmission of data in the transmission time interval may comprise determining that no data is to be transmitted in the transmission time interval.

The first threshold value may comprise at least one of radio link quality of service value and a value indicative of interference conditions.

Determining resources to be used for transmission of data in a transmission time interval may comprise determining at least one of transport block size, modulation and coding scheme and transmission power for the candidate resources.

The first threshold value may comprise a transport block padding size value. The method may comprise determining transport block size such that the padding size of the transport block is below the first threshold value.

Determining resources to be used for transmission of data in a transmission time interval may comprise determining whether to transmit using the candidate resources indicated by the at least one cell.

The at least one cell associated with the user device may comprise at least two cells of an ultra dense network.

The control information may comprise an indication of a cause for the determined resources.

The method may comprise receiving information from a network associated with the user device, the information comprising an indication to perform the determining.

The method may comprise receiving information from a network associated with the user device, said information comprising an indication to stop performing the determining.

In a second aspect there is provided a method comprising providing, to a user device associated with at least one cell, scheduling information, the scheduling information comprising an indication of candidate resources for transmission of data in a transmission time interval and receiving control information for transmission of data in the transmission time interval, said control information comprising an indication of the resources to be used for transmission of data in the transmission time interval, the resources determined in dependence on the candidate resources and at least a first threshold value.

The method may comprise receiving data in the transmission time interval using the determined resources.

The first threshold value may comprise at least one of a radio link quality of service value and a value indicative of interference conditions.

The determined resources to be used for transmission of data in a transmission time interval may comprise at least one of transport block size, modulation and coding scheme and transmission power for the candidate resources.

The first threshold value may be a transport block padding size value. The transport block size may be determined such that the padding size of the transport block is below the first threshold value.

The at least one cell associated with the user device may comprise at least two cells of an ultra dense network.

The control information may comprises an indication of a cause for the determined resources.

The method may comprise providing information to the user device, the information comprising an indication to perform said determining.

The method may comprise providing information to the user device, said information comprising an indication to stop performing the determining.

The information comprise a trigger to perform or stop performing said determining in dependence on whether the user device is operating in a multi-connectivity mode in an ultra dense network.

In a third aspect there is provided an apparatus, said apparatus comprising means for receiving, at a user device associated with at least one cell, scheduling information from the at least one cell, the scheduling information comprising an indication of candidate resources for transmission of data in a transmission time interval, means for determining, in dependence on the candidate resources and at least a first threshold value, resources to be used for transmission of data in the transmission time interval and means for providing control information for transmission of data in the transmission time interval to the at least one cell, said control information comprising an indication of the determined resources.

The apparatus may comprise means for transmitting data in the transmission time interval using the determined resources.

Means for determining resources to be used for transmission of data in the transmission time interval may comprise means for determining that no data is to be transmitted in the transmission time interval.

The first threshold value may comprise at least one of radio link quality of service value and a value indicative of interference conditions.

Means for determining resources to be used for transmission of data in a transmission time interval may comprise means for determining at least one of transport block size, modulation and coding scheme and transmission power for the candidate resources.

The first threshold value may comprise a transport block padding size value. The apparatus may comprise means for determining transport block size such that the padding size of the transport block is below the first threshold value.

Means for determining resources to be used for transmission of data in a transmission time interval may comprise means for determining whether to transmit using the candidate resources indicated by the at least one cell.

The at least one cell associated with the user device may comprise at least two cells of an ultra dense network.

The control information may comprise an indication of a cause for the determined resources.

The apparatus may comprise means for receiving information from a network associated with the user device, the information comprising an indication to perform the determining.

The apparatus may comprise means for receiving information from a network associated with the user device, said information comprising an indication to stop performing the determining.

In a fourth aspect there is provided an apparatus, said apparatus comprising means for providing, to a user device associated with at least one cell, scheduling information, the scheduling information comprising an indication of candidate resources for transmission of data in a transmission time interval and means for receiving control information for transmission of data in the transmission time interval, said control information comprising an indication of the resources to be used for transmission of data in the transmission time interval, the resources determined in dependence on the candidate resources and at least a first threshold value.

The apparatus may comprise means for receiving data in the transmission time interval using the determined resources.

The first threshold value may comprise at least one of a radio link quality of service value and a value indicative of interference conditions.

The determined resources to be used for transmission of data in a transmission time interval may comprise at least one of transport block size, modulation and coding scheme and transmission power for the candidate resources.

The first threshold value may be a transport block padding size value. The transport block size may be determined such that the padding size of the transport block is below the first threshold value.

The at least one cell associated with the user device may comprise at least two cells of an ultra dense network.

The control information may comprises an indication of a cause for the determined resources.

The apparatus may comprise means for providing information to the user device, the information comprising an indication to perform said determining.

The apparatus may comprise means for providing information to the user device, said information comprising an indication to stop performing the determining.

The information comprise a trigger to perform or stop performing said determining in dependence on whether the user device is operating in a multi-connectivity mode in an ultra dense network.

In a fifth aspect there is provided an apparatus comprising at least one processor and at least one memory including a computer program code, the at least one memory and the computer program code configured to, with the at least one processor, cause the apparatus at least to receive, at a user device associated with at least one cell, scheduling information from the at least one cell, the scheduling information comprising an indication of candidate resources for transmission of data in a transmission time interval, determine, in dependence on the candidate resources and at least a first threshold value, resources to be used for transmission of data in the transmission time interval and provide control information for transmission of data in the transmission time interval to the at least one cell, said control information comprising an indication of the determined resources.

The apparatus may be configured to transmit data in the transmission time interval using the determined resources.

The apparatus may be configured to determine that no data is to be transmitted in the transmission time interval.

The first threshold value may comprise at least one of radio link quality of service value and a value indicative of interference conditions.

The apparatus may be configured to determine at least one of transport block size, modulation and coding scheme and transmission power for the candidate resources.

The first threshold value may comprise a transport block padding size value. The apparatus may be configured to determine transport block size such that the padding size of the transport block is below the first threshold value.

The apparatus may be configured to determine whether to transmit using the candidate resources indicated by the at least one cell.

The at least one cell associated with the user device may comprise at least two cells of an ultra dense network.

The control information may comprise an indication of a cause for the determined resources.

The apparatus may be configured to receive information from a network associated with the user device, the information comprising an indication to perform the determining.

The apparatus may be configure to receive information from a network associated with the user device, said information comprising an indication to stop performing the determining.

In a sixth aspect there is provided at least one processor and at least one memory including a computer program code, the at least one memory and the computer program code configured to, with the at least one processor, cause the apparatus at least to provide, to a user device associated with at least one cell, scheduling information, the scheduling information comprising an indication of candidate resources for transmission of data in a transmission time interval and receive control information for transmission of data in the transmission time interval, said control information comprising an indication of the resources to be used for transmission of data in the transmission time interval, the resources determined in dependence on the candidate resources and at least a first threshold value.

The apparatus may be configured to receive data in the transmission time interval using the determined resources.

The first threshold value may comprise at least one of a radio link quality of service value and a value indicative of interference conditions.

The determined resources to be used for transmission of data in a transmission time interval may comprise at least one of transport block size, modulation and coding scheme and transmission power for the candidate resources.

The first threshold value may be a transport block padding size value. The transport block size may be determined such that the padding size of the transport block is below the first threshold value.

The at least one cell associated with the user device may comprise at least two cells of an ultra dense network.

The control information may comprises an indication of a cause for the determined resources.

The apparatus may be configured to provide information to the user device, the information comprising an indication to perform said determining.

The apparatus may be configured to provide information to the user device, said information comprising an indication to stop performing the determining.

The information comprise a trigger to perform or stop performing said determining in dependence on whether the user device is operating in a multi-connectivity mode in an ultra dense network.

In a seventh aspect there is provided a computer program embodied on a non-transitory computer-readable storage medium, the computer program comprising program code for controlling a process to execute a process, the process comprising receiving, at a user device associated with at least one cell, scheduling information from the at least one cell, the scheduling information comprising an indication of candidate resources for transmission of data in a transmission time interval, determining, in dependence on the candidate resources and at least a first threshold value, resources to be used for transmission of data in the transmission time interval and providing control information for transmission of data in the transmission time interval to the at least one cell, said control information comprising an indication of the determined resources.

The process may comprise transmitting data in the transmission time interval using the determined resources.

Determining resources to be used for transmission of data in the transmission time interval may comprise determining that no data is to be transmitted in the transmission time interval.

The first threshold value may comprise at least one of radio link quality of service value and a value indicative of interference conditions.

Determining resources to be used for transmission of data in a transmission time interval may comprise determining at least one of transport block size, modulation and coding scheme and transmission power for the candidate resources.

The first threshold value may comprise a transport block padding size value. The process may comprise determining transport block size such that the padding size of the transport block is below the first threshold value.

Determining resources to be used for transmission of data in a transmission time interval may comprise determining whether to transmit using the candidate resources indicated by the at least one cell.

The at least one cell associated with the user device may comprise at least two cells of an ultra dense network.

The control information may comprise an indication of a cause for the determined resources.

The process may comprise receiving information from a network associated with the user device, the information comprising an indication to perform the determining.

The process may comprise receiving information from a network associated with the user device, said information comprising an indication to stop performing the determining.

In an eighth aspect there is provided a computer program embodied on a non-transitory computer-readable storage medium, the computer program comprising program code for controlling a process to execute a process, the process comprising providing, to a user device associated with at least one cell, scheduling information, the scheduling information comprising an indication of candidate resources for transmission of data in a transmission time interval and receiving control information for transmission of data in the transmission time interval, said control information comprising an indication of the resources to be used for transmission of data in the transmission time interval, the resources determined in dependence on the candidate resources and at least a first threshold value.

The process may comprise receiving data in the transmission time interval using the determined resources.

The first threshold value may comprise at least one of a radio link quality of service value and a value indicative of interference conditions.

The determined resources to be used for transmission of data in a transmission time interval may comprise at least one of transport block size, modulation and coding scheme and transmission power for the candidate resources.

The first threshold value may be a transport block padding size value. The transport block size may be determined such that the padding size of the transport block is below the first threshold value.

The at least one cell associated with the user device may comprise at least two cells of an ultra dense network.

The control information may comprises an indication of a cause for the determined resources.

The process may comprise providing information to the user device, the information comprising an indication to perform said determining.

The process may comprise providing information to the user device, said information comprising an indication to stop performing the determining.

The information comprise a trigger to perform or stop performing said determining in dependence on whether the user device is operating in a multi-connectivity mode in an ultra dense network.

In a ninth aspect there is provided a computer program product for a computer, comprising software code portions for performing the steps the method of the first aspect when said product is run on the computer.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a schematic diagram of an ultra-dense-network (UDN) deployment;

FIG. 4 shows a schematic diagram of a proposed UDN frame structure;

FIG. 5 shows a flowchart of an example method of UE assisted coordination for scheduled wireless transmission;

FIG. 6 shows a schematic diagram of transport block adjustment;

FIG. 7 shows an example signalling flow;

FIG. 8 shows a schematic diagram of an example control apparatus;

### DETAILED DESCRIPTION

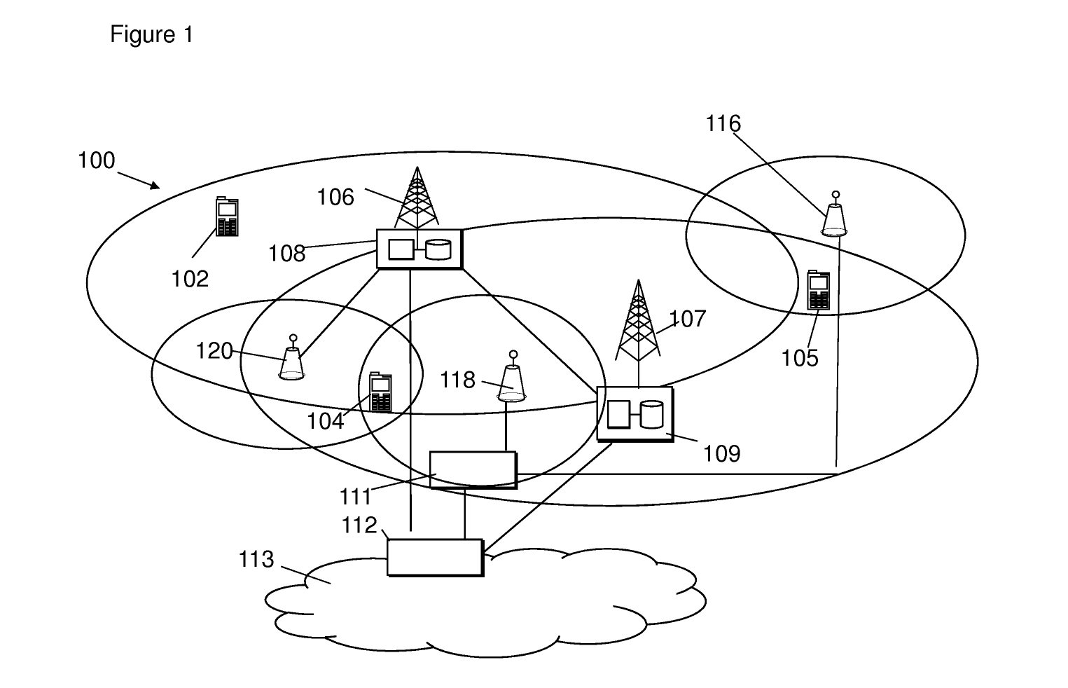

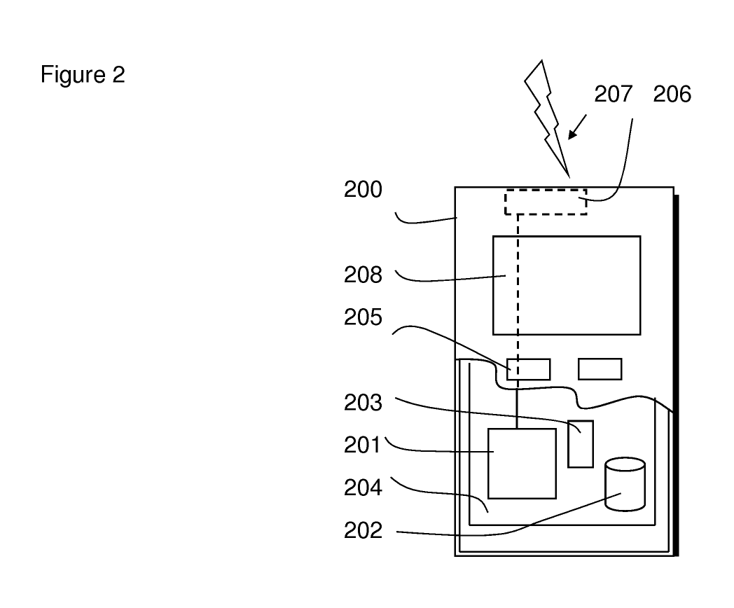

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on. Signalling mechanisms and procedures, which may enable a device to address in-device coexistence (IDC) issues caused by multiple transceivers, may be provided with help from the LTE network. The multiple transceivers may be configured for providing radio access to different radio technologies.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

The embodiments are not, however, restricted to the system given as an example but a person skilled in the art may apply the solution to other communication systems provided with necessary properties. Another example of a suitable communications system is the 5G concept. Network architecture in 5G may be similar to that of the LTE-advanced. 5G may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

The following relates to 5G systems, in which overall performance targets may include 10000× more traffic volume, 10-100× more connected devices and 10 Gbits/s peak data rate. To achieve these targets, mm-wave or cm-wave radio technologies may be adopted for new 5G radio interfaces. A UE may be served with a number of local small-cell 5G access points in parallel, forming an ultra-dense small-cell multi-connectivity environment. Such a small-cell multi-connectivity environment may meet reliability and robustness requirements.

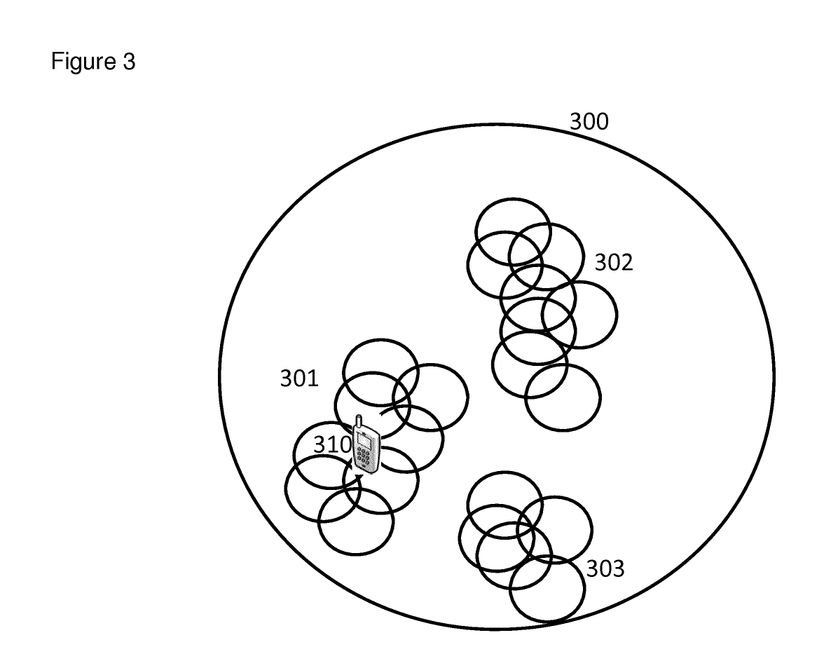

FIG. 3 illustrates an Ultra-Dense Network (UDN) deployment. UDN includes at least a small-cell layer comprising small cells 301, 302, 303 and may include an overlay macro-cell layer 300. The small-cell layer may comprise a large number of local-area dependent high-density deployed small-cell access nodes (AN). Examples of UDN use cases include in-door or out-door hotspot scenarios such as stadiums, popular squares, walking streets or landmark areas in big cities, large office or exhibition buildings, shopping malls or airports. In UDN, dynamic spectrum sharing among local small-cell ANs may be enabled to provide larger cell throughput and higher end-user data rate on demand. UE 310 may be in coverage area of many small cells, overlapping horizontally or vertically.

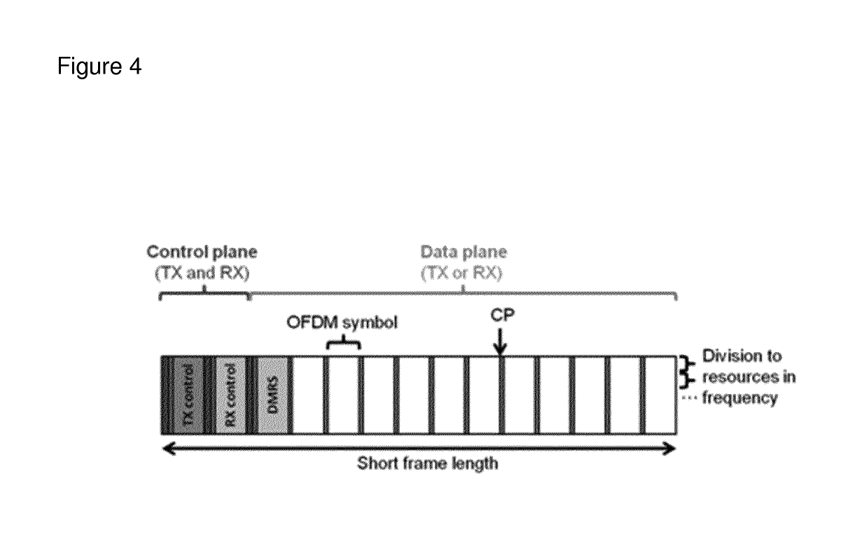

FIG. 4 illustrates an example of a proposed UDN optimized frame structure (METIS deliverable D2.3: Components of a new interface—building blocks and performance). The frame structure comprises a bidirectional control part embedded to the beginning of each frame and time separated from the data part (shown from the AN point of view in FIG. 4). The bidirectional control part includes TX control and RX control. Tx control may contain DL control information such as broadcast channel (BCH), UL hybrid automatic repeat request (HARQ) feedback, and scheduling grants. Rx control may contain UL control information such as random access channel (RACH), DL HARQ feedback, channel quality indication (CQI) reports, and scheduling requests. The control part may be designed with high reliability, avoiding interference from neighboring local ANs, e.g., by pre-defined/coordinated frequency resource allocation to the control part of each local AN.

In order to achieve low complexity, the data part in a UDN frame comprises only transmitting or receiving possibility for data symbols, which enables fully flexible UL/DL ratio switching for data transmission. However, the fully flexible UL/DL switching together with dynamic spectrum sharing in the data part may present challenges for interference coordination among the co-located local ANs in dense deployment.

Spectrum sharing coordination may be categorized as either a distributed or centralized scheme. The distributed schemes may allow fast and dynamic spectrum sharing by exchanging spectrum use and load information on shared spectrum or carrier between local ANs and/or monitoring inter-cell interference, with possible UE assistance in radio measurement and reporting. However, in local dense deployment of ANs, the information exchange among local ANs for spectrum sharing may introduce a lot of signalling overhead. In some deployment scenarios (e.g. uncoordinated deployment in single operator network or multi-operator involved dense deployment like the usage of unlicensed spectrum bands in the future) there might be some constraints on the information exchange due to lack of direct interface like X2-interface among local ANs.

In some centralized schemes, a spectrum sharing server and/or controller may be used to negotiate and/or coordinate the spectrum usage among the local ANs, which may imply spectrum sharing is negotiated on longer time scales, and the granularity of the spectrum sharing is on a higher level, than radio resource allocation granularity within each local AN. Therefore, centralized schemes may not work well for fast spectrum sharing in dynamic and adaptive manner and may be difficult to implement using multiple operator ANs.

The following relates to uncoordinated UDN deployment of 5G local ANs in spectrum sharing scenarios with multi-connectivity (MC) supports in which there may be no direct connections or interfaces between local ANs, and a UE may be connected to and served by more than 1 local AN with MC support. Given the UDN optimized frame structure as shown in FIG. 4 for 5G with extremely high peak bit rate and short TTI, network-side coordination among local serving ANs to schedule resources and transmissions for a UE in an uncoordinated UDN deployment of 5G local ANs may be too slow and complex.

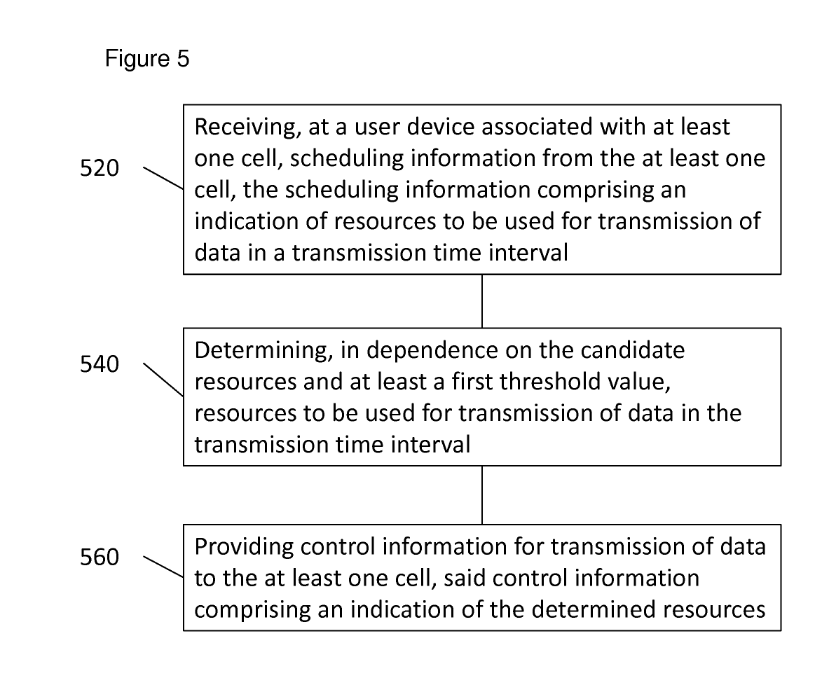

FIG. 5 shows a method of UE assisted coordination for scheduled wireless transmission. In a first step 520 the method comprises receiving, at a user device associated with at least one cell, scheduling information from the at least one cell, the scheduling information comprising an indication of candidate resources for transmission of data in a transmission time interval.

In a second step 540, the method comprises determining, in dependence on the candidate resources and at least a first threshold value, resources to be used for transmission of data in the transmission time interval.

In a third step 560, the method comprises providing control information for transmission of data in the transmission time interval to the at least one cell, said control information comprising an indication of the determined resources.

The method may comprise transmitting data in the transmission time interval using the determined resources.

Alternatively, or in addition, determining resources to be used for transmission of data in the transmission time interval may comprise determining that no data is to be transmitted in the time transmission interval.

Determining the resources to be used for transmission of data may comprise selecting and/or adjusting the candidate resources. The resources may comprise physical resource blocks (PRBs).

A method such as that shown in FIG. 5 provides for a per-TTI UE assisted coordination option in which UE is allowed to select and adjust candidate resources which have been indicated by a cell, e.g. scheduled UL grant(s), for actual UL transmission(s) toward serving AN(s) which may schedule for UE in MC independently. The resources may be determined to optimize one or both of radio transmissions for next TTI in terms of utilization of scheduled grant(s) in a coordinated manner and interference coordination among local ANs in UDN.

The method may be applicable for use with a flexible TDD L1 short frame structure, such as that described with reference to FIG. 4. The L1 frame structure, such as that in FIG. 4 may allow UE assisted coordination for fast spectrum sharing among the local ANs with MC support of the UE.

In an embodiment, the at least one cell is at least two cells of an ultra dense network. The user device may be a UE in a UDN. The at least one cell may be a local AN. For example, a UE in MC in an UDN may receive one UL grant from AN#i of the UDN and another UL grant from AN#j of the UDN scheduled for UL transmission in next TTI that is synchronized between AN#i and AN#j. UE, taking all received UL grant(s) as well as monitored resource allocation in UL for next TTI into account, coupled with optimized TB (Transport Block) size avoiding packet segmentation and padding as much as possible, may determine whether and how to transmit in UL for next TTI constrained to at least one of the received UL grant.

Determining resources to be used for transmission of data in a transmission time interval may comprise determining at least one of transport block (TB) size, modulation and coding scheme (MCS) and transmission (Tx) power for the candidate resources.

In one embodiment, the UE may be configured to determine selection and adjustment of the candidate resources, e.g. scheduled grant(s), for next TTI transmission(s) towards serving AN(s) which provide the candidate resources for UE independently (the configuration can be AN specific or common across the ANs serving the given UE). That is, whether and how to transmit in UL for next TTI constrained to candidate resources from at least one of the associated cells, e.g. from at least one of the scheduled grant received.

The first threshold value may comprise at least one of radio link quality of service value and a value indicative of interference conditions. The first threshold value may comprise a transport block (TB) size padding value. Determining resources to be used for transmission of data may comprise determining transport block size such that the padding size of the transport block is below the first threshold value.

For example, the determination on selection and adjustment of scheduled grants may be based on QoS characteristics of each L2 Radio Link (RL) queue as well as MC schemes (e.g. either duplicate or split scheme for MC that is packets are duplicated and transmitted over different MC legs to gain reliability or different packets are transmitted via different MC legs, respectively).

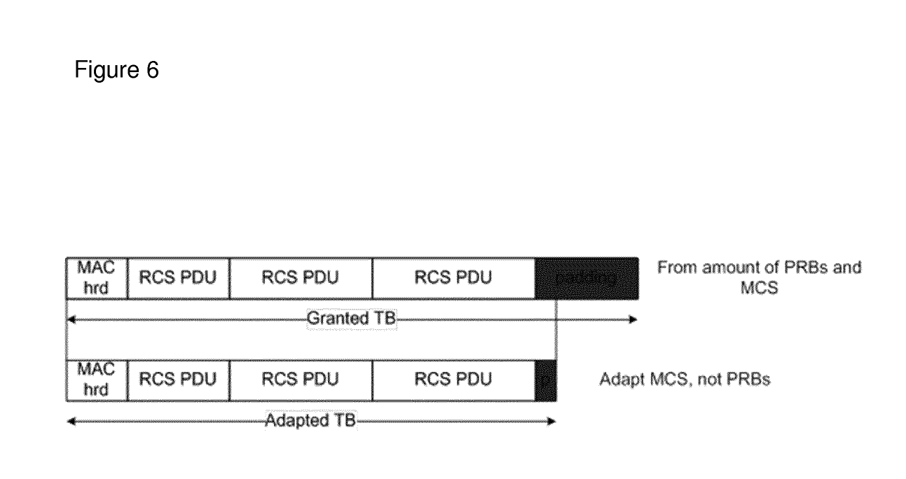

FIG. 6 illustrates an example driven by having optimized TB size and L2 radio convergence sub-layer (RCS) (similar to RLC in E-UTRAN) operation. This example may be applicable for user traffic flow with high data rate but without ultra-reliability requirement so that the traffic flow may be split into MC legs and each MC leg has independent RCS queue. In this example, it is beneficial (e.g., in processing wise) that each L2 RCS is allowed only to either aggregate or fragment packets in one PDU or, that is, minimizing the need of packet fragmentation. This, however, may lead to inefficient filling of scheduled TB size as granted to UE, as illustrated in FIG. 6. Determining resources to be used for transmission may comprise, if the padding of a scheduled TB goes above a configured threshold value adjusting the TB size so as to minimize the needed padding. Determining resources to be sued for transmission may comprise adapt parameters other than TB size (such as, e.g., MCS, Tx Power) accordingly. The adjustment of parameter such as TB size, MCS and Tx power may be constrained to the candidate resources, or received grant (e.g., not changing allocated PRBs).

In another example for user traffic flow that requires ultra reliability, MC legs may share one common RCS queue in order to have duplicated MC scheme. In this case, UE may take into account all UL grants from ANs and determine a common TB size for all MC legs.

Therefore, determining resources to be used for transmission may comprise expand TB size to for one or more MC legs, under constraints of at least one required parameter of the granted resource allocation in order to accommodate more data for next TTI and adapt other parameters accordingly. The UE is in MC and able to utilize diversity combining gain of MC to trade off impact of such the determined limited TB size increase. UE selection and adjustment of scheduled grant(s) for next TTI transmission(s), however, should aim to increase the likelihood for the transmission to succeed and not to cause harmful interference for others. In this regard, UE may be allowed to decide not to transmit. For example, a UE may determine not to cause a transmission if a value indicative of interference conditions is above a first threshold value.

Providing control information indicative of the determined resources to the at least one cell UE may involve notifying serving AN(s) of the determined resources, which may comprise an indication of control information (such as, but not limited to at least one of resource allocation, transport format, modulation and coding scheme and Tx power). The UE may indicate the determined resources in Rx control of a short frame as shown in FIG. 4 before actual UL transmission taking place. The same second-stage UE determined adjustment of scheduled grant may be applied for DL scheduling coordination as well.

In one embodiment, UE is configured to notify corresponding serving local AN(s) of the determined resources, e.g., selection and adjustment of scheduled grant(s) for next TTI transmission(s), in UL Rx Control part of the short frame. The UL Rx Control part used for the notification may or may not be in the same short frame the corresponding UL grant is valid. The grant may or may not be received in a different short frame the notification and/or the UL is sent).

The UE in MC may be allowed to send the notification to more than 1 local ANs simultaneously. The control information, or notification, may include an indication of some predefined “cause” of the determined selection and adjustment. The indication of the cause may be used by serving local AN(s) to trigger interference-and-resource coordination and control in the network side. The indication of the “cause” may be realized with bits of which different “cause” values indicate different predefined reasons, situations, conditions or purposes such as high interference, TB optimization, macro diversity replication with MC, and so forth. The information indicating the notification and cause thereof may also trigger the serving local AN(s) to adjust their resource allocations on both cell- and UE specific levels including UE specific scheduling grants in upcoming TTIs or possible reconfiguration of selection threshold values to ease UE's selection process.

This method may provide a fast, simple and effective UE assisted method for coordinating scheduled UL/DL transmission of UE with MC in uncoordinated UDN deployment of 5G local ANs.

In a method such as that of FIG. 5, a UE takes the central role in per-TTI fast coordination of UL radio transmissions towards serving local ANs which may independently schedule the UE for UL and DL. The coordination is realized with a fast second-stage UE determined adjustment of scheduled UL/DL grant(s) and a notification of that adjustment to serving local AN(s) using Rx/UL Control part of TDD L1 short frame (FIG. 4) before actual radio transmission for UE taking place.

Although UE is taking the central role in the coordination, the assistance by UE may be enabled or disabled on the fly by the network, i.e., the network may use the UE assisted coordination to achieve consensus on the scheduling between ANs and after reaching the consensus the assistance may be disabled to save resources. In an embodiment, information is provided to the user device, the information comprising an indication to perform said determining. Information may be provided to the user device, said information comprising an indication to stop performing the determining. The indication may comprise a trigger to perform or stop performing the determining in dependence on whether the user device is operating in a multi-connectivity mode in an ultra dense network.

In one embodiment, UE may be configured by the serving RAN using either dedicated signalling (like dedicated RRC procedure) or common signalling (like broadcast) to use the proposed UE assisted method. The trigger for this configuration may be, for instance, due to UDN deployment with MC support wherein UE may likely be served by more than 1 local AN. The enablement of MC for the given UE may also serve as a trigger for the configuration.

The network side may enable and utilize the proposed UE assisted coordination as means to achieve consensus among the serving ANs in the network side and then disable UE driven selection and adjustment of the scheduling grants. This is because the UE adjustment requires either preserved control channel resources (or part of data channel) for UE to notify about the event/adjustments or more processing by the ANs if certain level of blind decoding is allowed for detecting the UE transmissions.

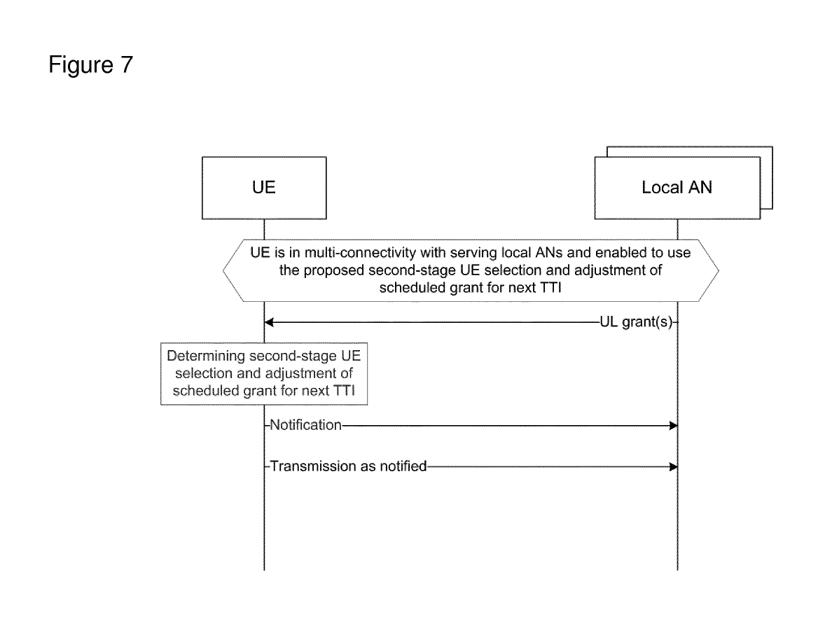

FIG. 7 illustrates an example signalling flow for the proposed fast second-stage UE determined adjustment of scheduled UL/DL grant(s) and a notification of that adjustment to serving local AN(s). A UE is in multi-connectivity with serving local ANs and enabled to use a second-stage UE selection and adjustment of scheduled grant next TTI, in line. The UE receives UL grant(s) from the local AN(s) and determines second-stage UE selection and adjustment of scheduled grant for the next TTI. The UE then provides a notification of the determination to the local AN and performs the transmission as notified.

If the UE does not need to do any selection and/or adjustment and thereof transmits according to the received grant as such, UE may skip the notification. That is, the omission of an explicit indication of the determined resources in control information provided to the AN may infer that the resources to be used for transmission are the candidate resources provided to the UE.

A method such as that described above provides a simple way to enable fast and simple UE centric coordination among the local ANs in UDN deployment with MC support. It does not require rapid information exchange among the local ANs to achieve dynamic spectrum sharing. The information exchange is mainly limited between UE and serving local ANs with acceptable additional functions introduced to UE side.

It should be understood that each block of the flowcharts of the Figures and any combination thereof may be implemented by various means or their combinations, such as hardware, software, firmware, one or more processors and/or circuitry.

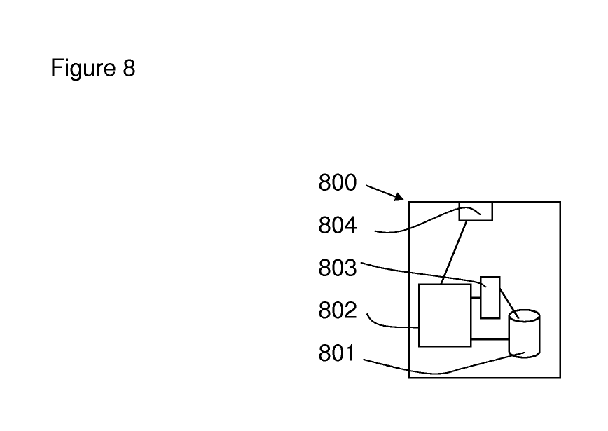

The method may be implemented on a mobile device as described with respect to FIG. 2 or control apparatus as shown in FIG. 8. FIG. 8 shows an example of a control apparatus for a communication system, for example to be coupled to and/or for controlling a station of an access system, such as a RAN node, e.g. a base station, (e) node B or 5G AN, a central unit of a cloud architecture or a node of a core network such as an MME or S-GW, a scheduling entity, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 800 can be arranged to provide control on communications in the service area of the system. The control apparatus 800 comprises at least one memory 801, at least one data processing unit 802, 803 and an input/output interface 804. Via the interface the control apparatus can be coupled to a receiver and a transmitter of the base station. The receiver and/or the transmitter may be implemented as a radio front end or a remote radio head. For example the control apparatus 800 or processor 201 can be configured to execute an appropriate software code to provide the control functions. Control functions may comprise receiving, at a user device associated with at least one cell, scheduling information from the at least one cell, the scheduling information comprising an indication of candidate resources for transmission of data in a transmission time interval, determining, in dependence on the candidate resources and at least a first threshold value, resources to be used for transmission of data in the transmission time interval and providing control information for transmission of data in the transmission time interval to the at least one cell, said control information comprising an indication of the determined resources.

Alternatively, or in addition, control functions may comprise providing, to a user device associated with at least one cell, scheduling information, the scheduling information comprising an indication of candidate resources for transmission of data in a transmission time interval and receiving control information for transmission of data in the transmission time interval, said control information comprising an indication of the resources to be used for transmission of data in the transmission time interval, the resources determined in dependence on the candidate resources and at least a first threshold value

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to UDN multi-connectivity systems, similar principles maybe applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
receiving, at a user device associated with at least one cell, scheduling information from the at least one cell, the scheduling information comprising an indication of candidate resources for transmission of data in a transmission time interval;
determining, in dependence on the candidate resources and at least a first threshold value, resources to be used for transmission of data in the transmission time interval; and
providing control information for transmission of data in the transmission time interval to the at least one cell, said control information comprising an indication of the determined resources.

2. A method according to claim 1 comprising: transmitting data in the transmission time interval using the determined resources.

3. A method according to claim 1 wherein determining resources to be used for transmission of data in the transmission time interval comprises determining that no data is to be transmitted in the transmission time interval.

4. A method according to claim 1, wherein the first threshold value comprises at least one of radio link quality of service value and a value indicative of interference conditions.

5. A method according to claim 1 wherein determining resources to be used for transmission of data in a transmission time interval comprises determining at least one of transport block size, modulation and coding scheme and transmission power for the candidate resources.

6. A method according to claim 5, wherein the first threshold value comprises a transport block padding size value and comprising determining transport block size such that the padding size of the transport block is below the first threshold value.

7. A method according to claim 1, wherein determining resources to be used for transmission of data in a transmission time interval comprises determining whether to transmit using the candidate resources indicated by the at least one cell.

8. (canceled)

9. A method according to claim 1, wherein said control information comprises an indication of a cause for the determined resources.

10. A method according to claim 1, comprising:
receiving information from a network associated with the user device, the information comprising an indication to perform the determining; and
receiving information from a network associated with the user device, said information comprising an indication to stop performing the determining.

11. (canceled)

12. A method comprising:
providing, to a user device associated with at least one cell, scheduling information, the scheduling information comprising an indication of candidate resources for transmission of data in a transmission time interval; and
receiving control information for transmission of data in the transmission time interval, said control information comprising an indication of the resources to be used for transmission of data in the transmission time interval, the resources determined in dependence on the candidate resources and at least a first threshold value.

13. A method according to claim 12 comprising: receiving data in the transmission time interval using the determined resources.

14. A method according to claim 12, wherein the first threshold value comprises at least one of a radio link quality of service value and a value indicative of interference conditions.

15. A method according to claim 12 wherein the determined resources to be used for transmission of data in a transmission time interval comprise at least one of transport block size, modulation and coding scheme and transmission power for the candidate resources.

16. A method according to claim 15, wherein the first threshold value is a transport block padding size value and the transport block size is determined such that the padding size of the transport block is below the first threshold value.

17. (canceled)

18. A method according to claim 12, wherein said control information comprises an indication of a cause for the determined resources.

19. A method according to claim 12, comprising:
providing information to the user device, the information comprising an indication to perform said determining; and
providing information to the user device, said information comprising an indication to stop performing the determining.

20. (canceled)

21. A method according to claim 19, wherein the information comprise a trigger to perform or stop performing said determining in dependence on whether the user device is operating in a multi-connectivity mode in an ultra dense network.

22. A computer program product for a computer, comprising software code portions for performing the steps of claim 1 when said product is run on the computer.

23. (canceled)

24. An apparatus comprising:
at least one processor and at least one memory including a computer program code, the at least one memory and the computer program code configured to, with the at least one processor, cause the apparatus at least to:
receive, at a user device associated with at least one cell, scheduling information from the at least one cell, the scheduling information comprising an indication of candidate resources for transmission of data in a transmission time interval;
determine, in dependence on the candidate resources and at least a first threshold value, resources to be used for transmission of data in the transmission time interval; and
provide control information for transmission of data in the transmission time interval to the at least one cell, said control information comprising an indication of the determined resources.

25. (canceled)

26. A computer program product for a computer, comprising software code portions for performing the steps of claim 12 when said product is run on the computer.
